(19) United States
(12) Patent Application Publication
(10) Pub. No.: US 2020/0309905 A1
(43) Pub. Date: Oct. 1, 2020

(54) SYSTEM AND METHOD OF PERSISTENT DETECTION

(71) Applicant: Booz Allen Hamilton Inc., McLean, VA (US)

(72) Inventors: Adam WEINER, Northborough, MA (US); Scott Paul QUIGLEY, Franklin, MA (US); William Paul CONLEY, Stow, MA (US); Anthony Ray HEFNER, Raleigh, NC (US); Austin Tyler JAMES, Cambridge, MA (US); Jonathan M. LEVITT, Boston, MA (US); Matthew Steven PAUL, Worcester, MA (US); Mehrnaz MORTAZAVI, Santa Monica, CA (US); Wade LEONARD, Springfield, VA (US); Zachary ROHDE, Los Angeles, CA (US); Michael CALABRO, Alexandria, VA (US); Alex SAUNDERS, El Segundo, CA (US)

(73) Assignee: Booz Allen Hamilton Inc., McLean, VA (US)

(21) Appl. No.: 16/805,006

(22) Filed: Feb. 28, 2020

Related U.S. Application Data
(60) Provisional application No. 62/823,405, filed on Mar. 25, 2019.

(51) Int. Cl. G01S 7/40; G01S 13/74

(52) U.S. Cl. CPC G01S 7/4021; G01S 7/038; G01S 13/74

(57) ABSTRACT

An exemplary detection apparatus includes a housing having one or more sensors of one or more sensor types, an optional port for detachably mounting one or more of the sensors, and an optional motive system associated with a mode of transport for movement in an area of interest. A sensor circuit receives a signal originating from the one or more sensors, identifies the signal, optionally processes the signal data, and packages the raw signal data or processed signal data, as applicable, for transmission over a network. A control circuit establishes communication with the network for sending or receiving sensor data to/from other devices connected to the network, and controls the motive system for moving the apparatus to locations in the area of interest.

### FIELD

The present disclosure relates to detecting and tracking signals in an area of interest.

### BACKGROUND INFORMATION

Remote sensing devices can be designed for various objectives by using form factors and implementing functional characteristics that are appropriate for the intended purposes and environments.

Sonobuoys are remote sensing devices having both a surface feature and a sub-surface feature. The surface feature can include an inflatable surface having a radio transmitter for communication with a control center. The sub-surface feature includes one or more hydrophone sensors and stabilizing equipment deployed at depths appropriate for environmental conditions and search pattern. The sonobuoy can use UHF/VHF radio to relay acoustic information from its hydrophone(s) to operators at a remote location.

Weather buoys are another type of remote sensing device. Weather buoys are weather stations that measure environmental parameters such as air temperature above the ocean surface, wind speed (steady and gusting), barometric pressure, and wind direction. They can also measure water temperature, wave height, and dominant wave period. Raw data is processed and can be logged on board and transmitted via radio, cellular, or satellite communications to command centers. Weather buoys can be stationary or allowed to drift with the current.

A water monitoring buoy station typically consists of several components, including a buoy platform, data logger, solar power, telemetry equipment, mooring hardware, temperature string, sondes, and sensors. Buoy sensors can be customized and modified as water quality research and monitoring priorities change. Buoys can house from one to hundreds of sensors, meeting the corresponding needs and applications. Buoy platforms can communicate with servers and online systems for data access and sensor control.

Improvements in remote sensing technology would facilitate surveilling coast lines, beaches, or river banks for human activity prior to engaging in further operations in the area of interest.

### SUMMARY

An exemplary detection system is disclosed, comprising plural detection devices configured to be deployed in an area of interest, each detection device including: a housing with an attached sensor type or having a port for detachably mounting one or more sensors of one or more sensor types; one or more sensor circuits configured to receive sensor data from the sensors and package the sensor data for transmission over a network; and a control circuit configured to establish communication with the network for sending or receiving sensor data to or from, respectively, other devices connected to the network.

An exemplary detection apparatus is disclosed, comprising: a housing having one or more ports for detachably mounting one or more sensors of one or more sensor types and including a motive system associated with a mode of transport for movement in an area of interest; a sensor circuit configured to receive sensor data via the port and package the sensor data for transmission over a network; and a control circuit configured to: establish communication with the network for sending or receiving sensor data to or from other devices, respectively, that are connected to the network; and control the motive system of the housing for moving the apparatus to locations in the area of interest.

An exemplary method for detection in an area of interest is disclosed, comprising: deploying one or more mobile detection devices in the area of interest; detecting, via a sensor mounted to a first detection device, a signal in the area of interest; processing, via the first detection device, the signal to generate sensor data that identifies or tracks an object in the area of interest; superimposing, via the first detection device, geo-location or spatial data of the object and the detection device onto the sensor data; processing, via the one or more second detection devices, their respective signals from the area of interest to generate respective processed sensor data that identifies or tracks the object in the area of interest and superimposing their respective geo-location or spatial data onto their respective processed sensor data; one or more second detection devices transmitting via a network to the first detection device their processed data with their superimposed geo-location or spatial sensor data related to the object in the area of interest; the first detection device receiving via the network from the one or more second detection devices their respective processed sensor data with their superimposed geo-location or spatial sensor data related to the object in the area of interest; superimposing, via the first detection device, the geo-location or spatial data of the object and the first detection device onto the sensor data; and moving, the first detection device relative to or in coordination with the one or more second detection devices to maintain observation of the detected object.

### BRIEF DESCRIPTION OF THE DRAWINGS

The scope of the present disclosure is best understood from the following detailed description of exemplary embodiments when read in conjunction with the accompanying drawings, wherein:

FIG. 1 illustrates architecture of a detection device in accordance with an exemplary embodiment of the present disclosure.

FIGS. 2A and 2B illustrate perspective views of an exemplary circuit card in accordance with an exemplary embodiment of the present disclosure.

FIG. 3A and 3B illustrate perspective views of an exemplary detection assembly in accordance with an exemplary embodiment of the present disclosure.

FIG. 4 illustrates an end-to-end communications system architecture for the sensor circuit in accordance with an exemplary embodiment of the present disclosure.

FIG. 5 illustrates an RF test architecture for the neural network functioning as a modulation classifier.

FIGS. 6A and 6B illustrate an input vector and method of formatting an input training vector for a modulation classifier according to an exemplary embodiment of the present disclosure.

FIGS. 7A-7C illustrate modulation classifications in accordance with an exemplary embodiment of the present disclosure.

FIG. 8 illustrates an exemplary architecture of a detection system in accordance with an exemplary embodiment of the present disclosure.

FIGS. 9-13 illustrate exemplary visualizations generated by the command server in accordance with an exemplary embodiment of the present disclosure.

FIG. 14 illustrates an exemplary detection method in accordance with an exemplary embodiment of the present disclosure.

### DETAILED DESCRIPTION

Exemplary embodiments of the present disclosure are directed to a remote sensing and detection device that is sensor-agnostic and can be used with any of a plurality of sensor types. Plural detection devices can be deployed in an area of interest for detecting and tracking human activity through communicating and exchanging detected data over a network. The device includes circuitry for processing raw sensor data to identify an object and track its movements. The circuitry can also control movement of the detection device based on the object being tracked. The movement of the device can be coordinated with other detection devices through communication over the network.

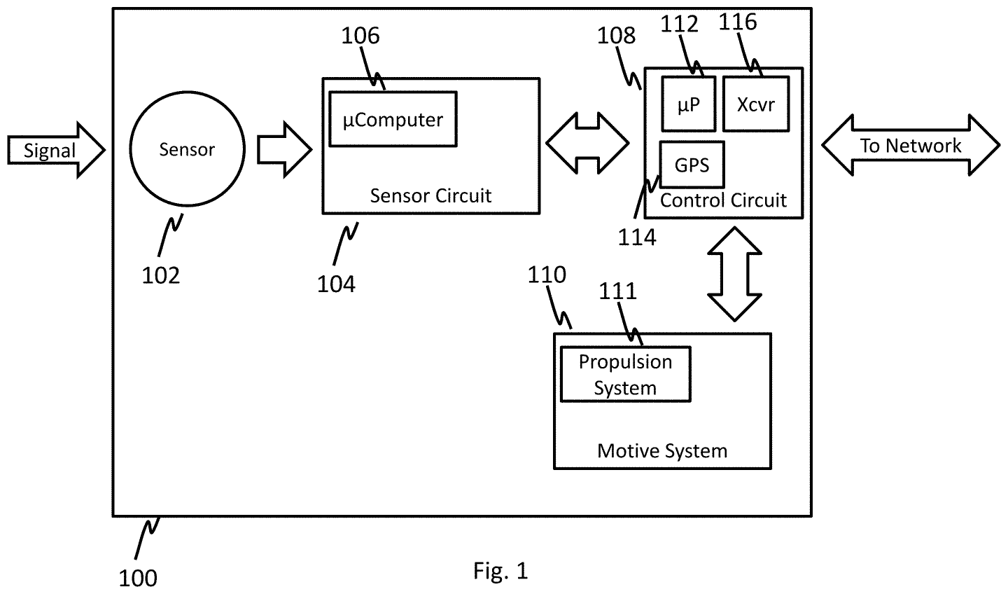

FIG. 1 illustrates architecture of a detection device in accordance with an exemplary embodiment of the present disclosure.

As shown in FIG. 1, a detection device or apparatus 100 can include a sensor 102 of any known type for detecting events or changes in an area of interest in which the detection device 100 is deployed. According to an exemplary embodiment, the sensor 102 can be configured to detect images, light, motion, temperature, magnetic fields, vibration, pressure, electrical fields, sound, radio frequencies, or any other suitable characteristic within an area of interest as desired.

The detection device 100 can also include a sensor circuit 104 configured to receive raw data from the sensor 102. The sensor circuit 104 can include a microcomputer 106, such as a Raspberry Pi. According to an exemplary embodiment, the microcomputer 106 can be configured to process the received sensor signal to detect and/or identify an object, and package the sensor data for transmission over a network. According to an exemplary embodiment the microcomputer 106 can be configured with software algorithms for classifying a detected signal. Once the signal is classified, the sensor data can be converted to protocol buffers and sent from the sensor circuit 104 to a control circuit 108 of the detection device 100.

The control circuit 108 is configured to establish communication with a network for sending or receiving sensor data to/from other devices connected to the network, and control a motive system 110 with a propulsion system 111 for moving or positioning the detection device 100 to a location in the area of interest for identifying, tracking or detecting an object. The control circuit 108 can include a hardware processor 112 such as an ATMEL microcontroller or other suitable processing device as desired. The control circuit 108 can include a global positioning system (GPS) module 114 that can provide geo-location or spatial position information, which the hardware processor 112 can superimpose onto a data signal having the sensor data. The control circuit 108 can also include a transceiver 116, such as an Xbee PrO900HP RF Module, or other suitable communication device as desired. The control circuit 108 can be configured with program code for processing data according to the appropriate protocol and in combination with the transceiver 116 connect to the network for communicating sensor data and control information.

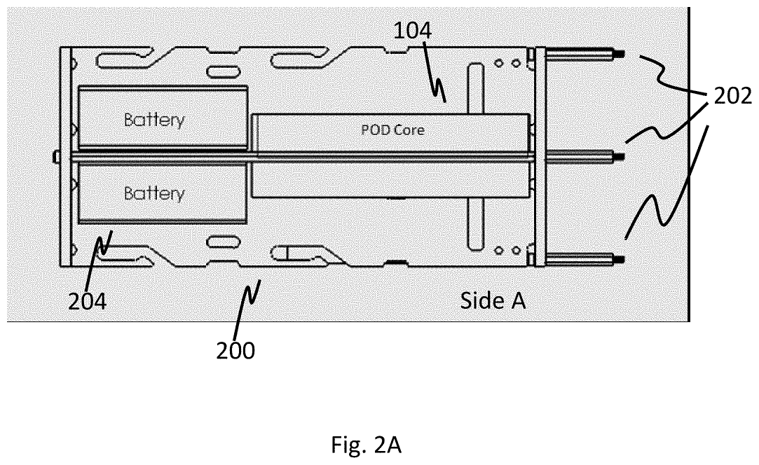

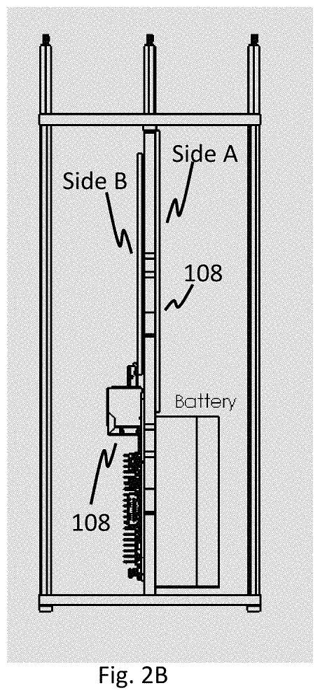

FIGS. 2A and 2B illustrate perspective views of an exemplary substrate in accordance with an exemplary embodiment of the present disclosure.

As shown in FIGS. 2A and 2B, the detection device 100 comprises a removable substrate 200 on which the electronic circuitry is mounted. The substrate can be a double-sided substrate where each circuit and/or circuit components can be disposed. For example, the sensor circuit 104 can be disposed on a side A of the substrate 200 and the control circuit 108 can be disposed on a side B of the substrate 200. The substrate 200 can be formed as a printed circuit board (PCB) or circuit card with one or more pins 202 that allow mounting within a housing.

The substrate 200 can include one or more batteries 204 for supplying operating power to the sensor circuit 104 and control circuit 108. Each battery 204 can be a rechargeable power supply. For example, the battery can have several different combinations of electrode materials and electrolytes, including nickel-cadmium (NiCd), nickel-metal hydride (NiMH), lithium-ion (Li-ion), and lithium-ion polymer (Li-ion polymer). According to an exemplary embodiment the battery 204 can be connected to one or more photovoltaic cells 206. The control circuit can include one or more DC/DC converters for converting energy generated by the photovoltaic cells to energy for storing in the batteries 204. In addition, one or more DC/DC converters are used to convert energy generated by the photovoltaic cells and/or stored in the battery 204 to power the sensor circuit 104 and control circuit 108.

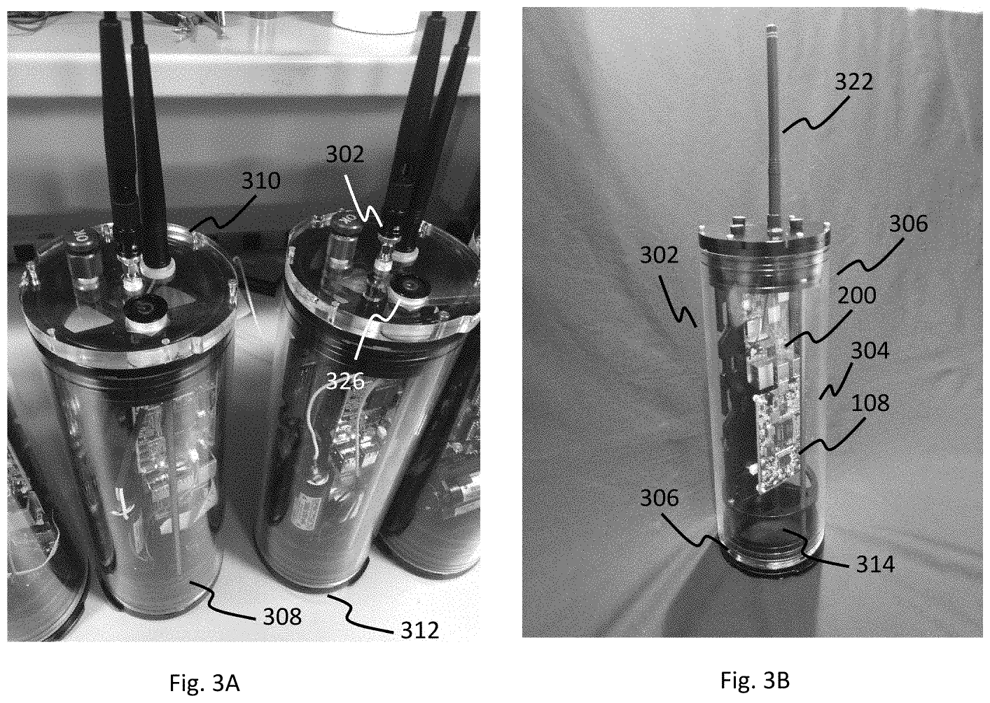

FIGS. 3A and 3B illustrate perspective views of an exemplary detection assembly in accordance with an exemplary embodiment of the present disclosure.

As shown in FIG. 3 the detection assembly 300 includes a housing 302 having a chamber 304. The substrate 200 with the sensor circuit 104 and control circuit 108 mounted thereon is disposed within the chamber 304 of the housing 302. The housing 302 can include a support ring 306 at a top or bottom end. The support ring 306 can include threaded holes 308 for receiving the pin 202 of the substrate 200. The one or more pins 202 can be screwed into the threaded holes 308 for securely mounting the substrate 200 within the chamber 304 of the housing 302. For disassembly, the substrate 200 can be easily removed by unscrewing the pins 202 from the support ring 306. The housing 302 can be of any shape and/or configuration suitable for mounting the substrate 200 and protecting the substrate 200 from the environment. The detection assembly 300 can be configured for deployment in a body of water. The detection assembly 300 includes top and bottom covers 310, 312 which provide tight seals to protect the substrate from particles and/or fluids in the area of interest. For areas of interest involving a body of water, the bottom cover 312 can include an adjustable weighting system to control buoyancy. The weighting system can use a combination of water, air, and or adjustable weights for controlling a full or partial submersion of the housing 302. For example, the weighting system can operate to control inflation of a bladder 314 to control full or partial submersion of the housing 302 relative to the surface of the body of water.

The housing 302 can include the motive system 110 associated with a mode of transport for movement in the area of interest. For example, the motive system 110 can be configured with the propulsion system 111 for movement through a medium that is characteristic of the area of interest. According to an exemplary embodiment, the propulsion system 111 can be configured for movement of the detection device over land or through air, space, or water. The propulsion system 111 can include an electric motor for driving one or more of a wheel and axle system, a propeller system, or other suitable mechanism or system for traversing through the medium.

The top cover 310 of the detection assembly 300 can include a port 320 for connecting to the specified sensor 102. For example, according to an exemplary embodiment the sensor 102 can include an antenna 322 for detecting an RF signal transmitted by an object or source in the area of interest. The top cover can also include an antenna 324 connected to the transceiver 116 of the control circuit 108 for communicating data over a network. The top cover 310 can also include a power switch 326 for manually placing the assembly 300 into a powered on or powered off mode. According to an exemplary embodiment, the control circuit 108 can be configured with program code to place the detection device 100 into a sleep mode for power conservation in addition to the power on and power off modes. During a controlled submersion, the depth of the submersion can be specified such that the top cover 310 of the assembly 300 including the sensor 102 and/or network antenna 324 are not visible on the surface of the water.

According to an exemplary embodiment the control circuit 108 can be configured to execute or initiate a scuttle mode that allows for immediate or gradual (e.g., performed over a period of time) destruction of the detection assembly 300. The scuttle mode can be configured to activate based on an elapsed time or according to a specified date or time. Alternatively, the scuttle mode can activate based on remote control from another detection device or from a command center. The scuttle mode can include a combination of software and/or hardware operations. The software operation can involve erasing all on-board memory devices and placing the processor into a brick state and/or sinking the device. Hardware operations can include full or partial destruction of one or more components, systems, or structures of the assembly 300 using explosive detonation, acid release, or any other suitable destructive process or material as desired.

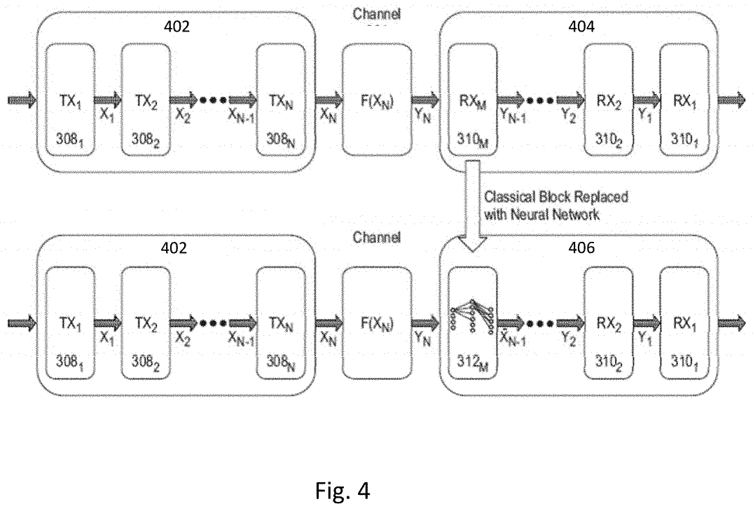

FIG. 4 illustrates an end-to-end communications system architecture for the sensor circuit in accordance with an exemplary embodiment of the present disclosure.

As shown in FIG. 4, the sensor circuit 104 can include a transmitter device 402 and a receiver device 404 both of which can include a mixture of neural network based and classical communications processing blocks. The transmitter device 402 and receiver device 404 communicate over a channel 404. In an exemplary embodiment, signal processing components including timing recovery, frequency recovery, and demodulation have been replaced by an equivalent trained neural network 406 in the receiver device 404. Similarly, signal processing components including modulation and coding can be replaced by the equivalent trained neural network in the transmitter device 402. As described later, this type of architecture has several novel applications and can enable new types of radio communications.

In an exemplary embodiment, the processing performed by the neural network 406 in the receiver device 404 includes classifying a modulation scheme of the digital signal, and the digital signal is processed based on the determined classification of the modulation scheme. In an exemplary embodiment, the processing of the digital signal based on the determined classification of the modulation scheme can be performed by a known signal processing component (i.e., a non-neural network component) or multiple known signal processor components, or a different neural network. The modulation scheme of the digital signal can be Phase Shift Keying (PSK) modulation, Frequency Shift Keying modulation (FSK), Pulse Amplitude Modulation (PAM) modulation, Gaussian Minimum Shift Keying (GMSK) modulation, Continuous Phase Modulation (CPM), Quadrature Amplitude Modulation (QAM), or any other modulation scheme. In an exemplary embodiment, the neural network 406 of the receiver device 402 can classify any of the above-noted modulation schemes.

In an exemplary embodiment, the received RF signal is any one type among two or more types of RF signals, and the classified modulation scheme of the digital signal is unique amongst the modulation schemes of the two or more RF signals. That is, the neural network 406 is able to receive one of any number of unique signal types, and classify the signal type. Under one example of a known approach, if there are ten signal types, the received signal would be compared to the first signal type, then to the second signal type, then to the third signal type, and so on. Each signal type comparison requires its own unique signal processing operations. In contrast, in the receiver device 404 with the neural network 406 of the present disclosure, estimation of which of the ten signal types is received requires fewer processing cycles through a single common neural network.

In an exemplary embodiment, the neural network is trained to classify the digital signal. Waveform processing is done conditionally based on the classification of the digital signal by the neural network 406.

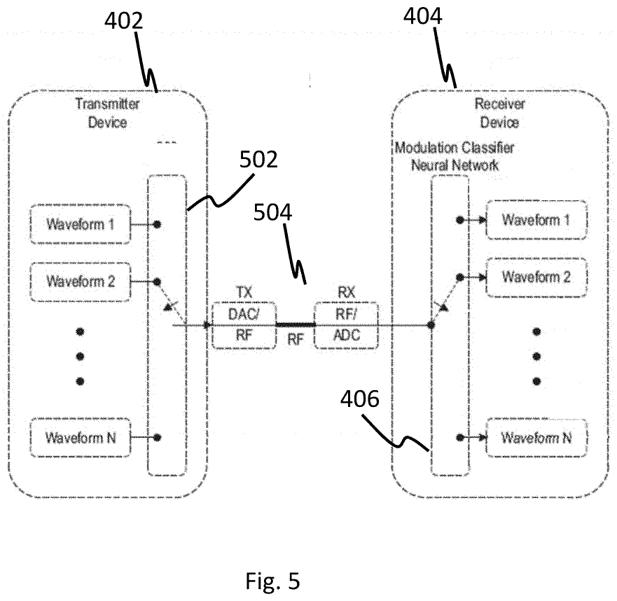

FIG. 5 illustrates an RF test architecture for the neural network 406 functioning as a modulation classifier. The system includes the transmitter device 402 and the receiver device 404. The transmitter device 402 includes a transmitter switch 502 (e.g., a switch device) that selects one of N waveforms (e.g., Waveform 1, Waveform 2, . . . , Waveform N) for DAC/RF processing and transmission over a channel 504, where N can be any integer number. The neural network 406 of the receiver device 404 is configured to classify the received signal as one of N possible signals. The received signal is then routed to the appropriate waveform processor (e.g., Waveform 1 Processor, Waveform 2 Processor, . . . , Waveform N Processor) based on the classification decision made by the neural network 406.

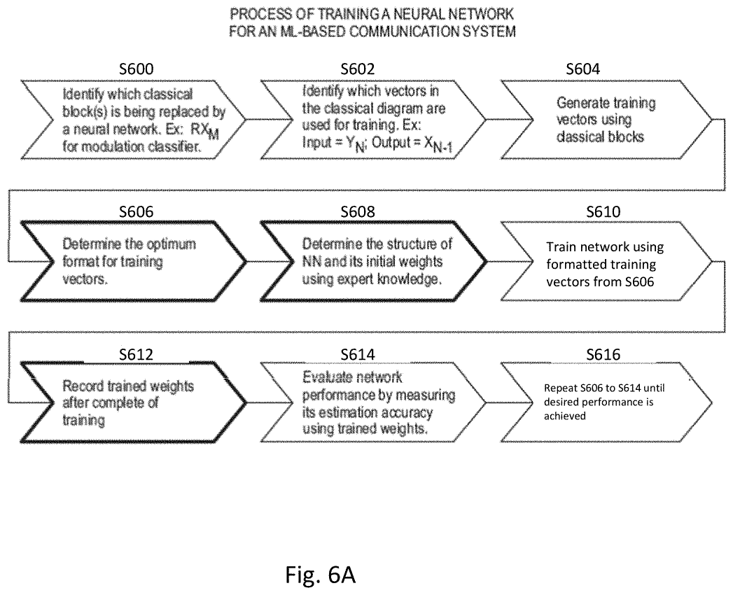

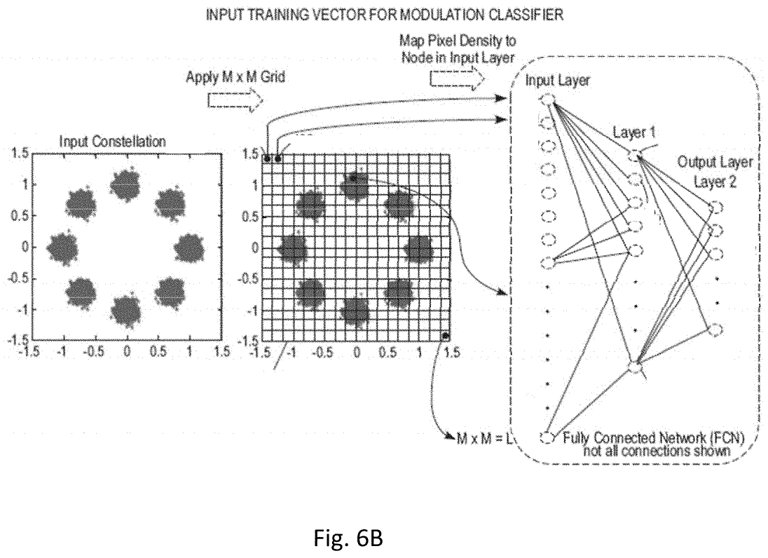

FIGS. 6A and 6B illustrate an input vector and method of formatting an input training vector for a modulation classifier according to an exemplary embodiment of the present disclosure. In step S600, the known block(s) that is being replaced by a neural network is identified. For example, RXM ( )for a modulation classifier in FIG. 4. In step S602, vectors in the classical diagram that are used for training the neural network are identified (e.g., input=YN; output=XN−1). In step S604, training vectors are generated using classical signal processing blocks. In step S606, the optimum format for training vectors is determined. For example, the format could be two-dimensional (2-D) constellation points 606, 608 from an input constellation 602 with resolution dictated by the amount/type of channel distortion. Step S608 includes determining the structure of the neural network and its initial weights using, for example, expert knowledge. For example, a two-layer model of the neural network can be used to identify modulation based on a 2-D constellation input. The first layer (e.g., Layer 1 in FIG. 6B) identifies centers of mass on the constellation plot and the second layer (e.g., Layer 2 in FIG. 6B) identifies the modulation based on the combination of identified centers of mass. For example, for the number of neurons per layer, the number of neurons in the first layer can be greater than the expected number of distinct centers of mass. In an exemplary embodiment, the number of neurons in the second layer is equal to the number of modulations to be classified.

Step S610 includes training the neural network using formatted training vectors from Step S606. Step S612 includes recording the trained weights after completion of the training. Step S614 includes evaluating neural network performance by measuring its estimation accuracy using the trained weights. Step S616 includes repeating steps S606 to S614 until the desired performance is achieved.

In an exemplary embodiment, the processing performed in the sensor circuit 104 can be the classifying of a modulation scheme of the digital signal, and the digital signal can be processed based on the determined classification of the modulation scheme. The sensor circuit 104 can be configured to receive an RF signal of any one type among two or more types of RF signals, and the classified modulation scheme of the digital signal can be unique amongst the modulation schemes of the two or more RF signals. The sensor circuit 104 can be configured to process the digital signal based on the determined classification of the modulation scheme. The sensor circuit 104 can be configured to include one or more neural networks. In the case of plural neural networks, two or more neural networks can be connected in series or parallel.

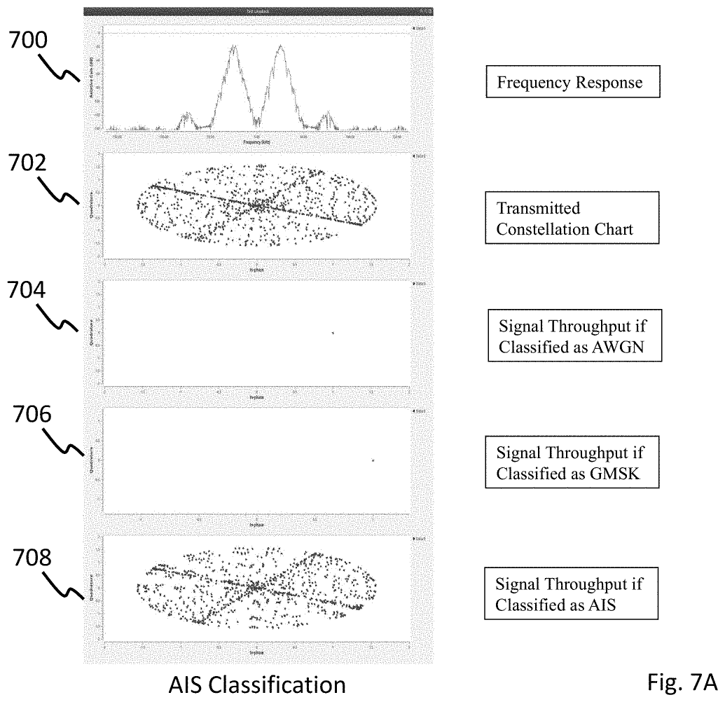

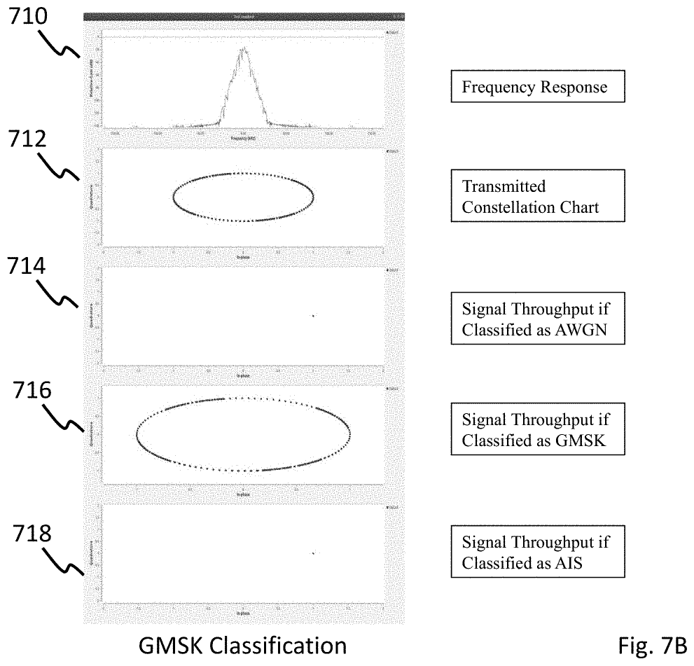

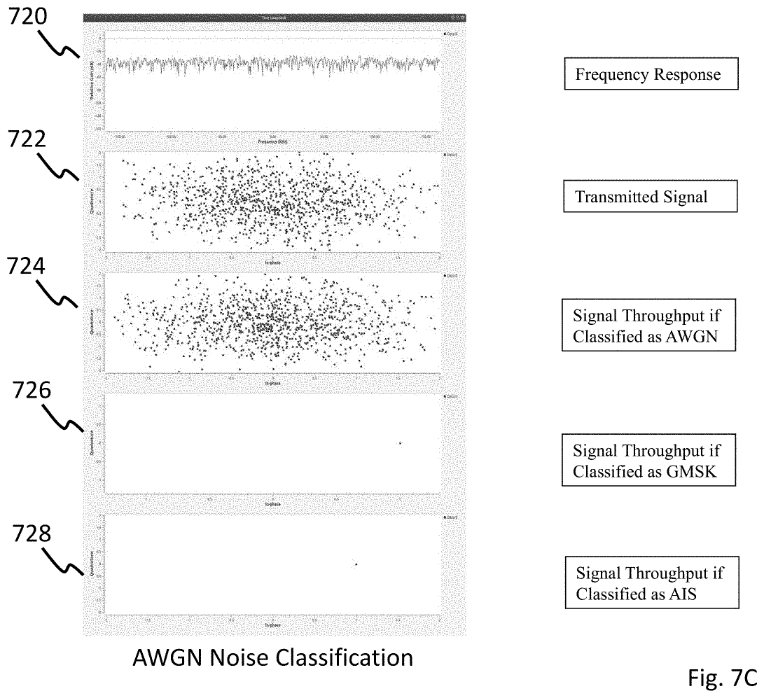

FIGS. 7A-7C illustrate modulation classifications in accordance with an exemplary embodiment of the present disclosure.

Each of FIGS. 7A-7C shows the resulting signal throughput generated by the modulation classifier based on a frequency response 700, 710, 720 of a received signal and an input constellation chart. The signal is processed in the modulation classifier based on reference constellation charts to determine its modulation scheme. The modulation classifier is trained to classify the received signals according to the constellation charts according to the process of FIGS. 6A and 6B as described herein. For example, FIG. 7A illustrates the reference or input constellation 702 of an AIS modulation scheme; FIG. 7B illustrates a reference constellation 712 of a GMSK modulation scheme; and FIG. 7C illustrates a reference constellation 722 of an AWGN modulation scheme. The modulation classifier will only provide signal throughput (708, 716, 724) for an input signal that correlates to one of the reference constellations supplied during the training process.

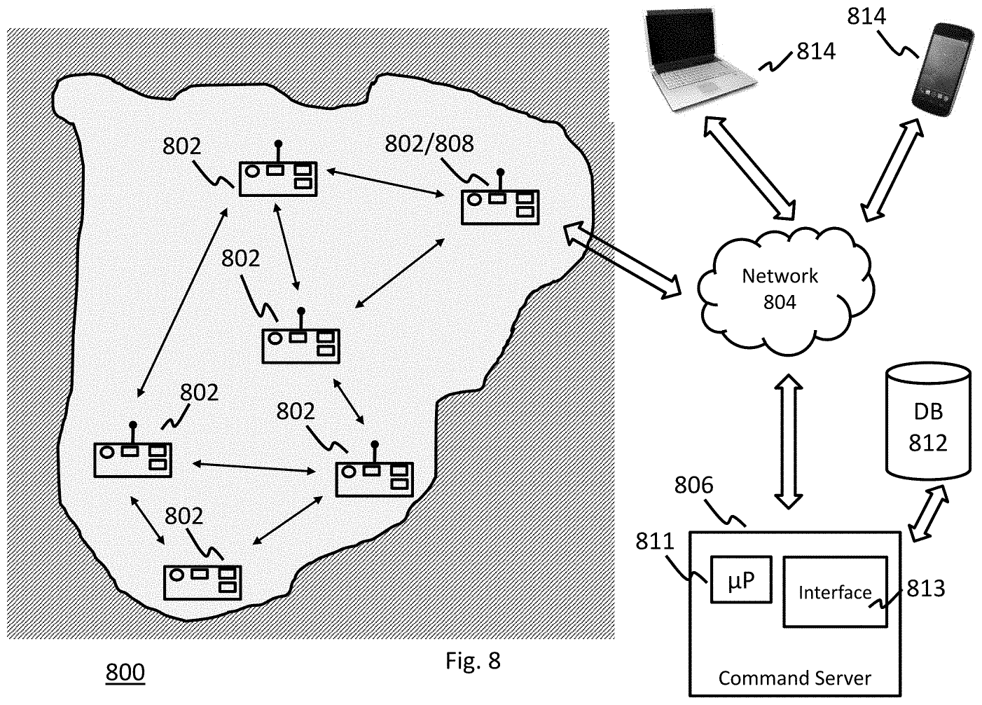

FIG. 8 illustrates an exemplary architecture of a detection system in accordance with an exemplary embodiment of the present disclosure.

As shown in FIG. 8, a detection system 800 includes plural detection devices 802 that are deployed in an area of interest and connected to a mesh network 804. The system 800 can also include a command server 806 configured to monitor and control each deployed detection device 802 within the area of interest. According to an exemplary embodiment, each detection device 802 can independently process the data detected by a respective sensor. For example, each detection device 802 can be configured to identify the detected signal, generate a protocol buffer and populate the protocol buffer with the signal type and the number of frames used to identify the signal. The protocol buffer is sent over a serial connection to the control circuit 108. The control circuit 108 packages the protocol buffer into a data frame for transmission over the mesh network 804. According to another exemplary embodiment, rather than processing the detected signal or data, each detection device 802 can be configured to transmit the raw sensor data to the command server 806 for further processing such as identification or tracking of an object.

According to an exemplary embodiment, one or more of the plural detection devices 808 is configured as an uplink/downlink device between the other detection devices 802 and the command server 806. Such that any data leaving or entering the network 804 on the command server side must pass through the uplink/downlink device 808.

According to yet another exemplary embodiment one or more of the plural detection devices 802 is configured to perform command and control operations as it relates to other detection devices deployed in the area of interest. For example, a command and control detection device 810 can be configured to receive geo-location or spatial position data from at least one other detection device. Based on the received geo-location or spatial location data of the other detection device and the detected geo-location or spatial location data of an object based on the received sensor data, the command and control detection device 810 can be configured to control the motive system 316 of the other detection device 802 for coordinating a respective position or movement of the other detection device 802 for further detection of a signal or source, or tracking of an object in the area of interest. The movement of the other detection devices 802 can include submersion operations or activating the propulsion system on each respective detection device 802 for movement to a specified spatial position or geo-location. The command and control of other detection devices 802 can also involve a scuttle operation, where each detection device 802 is immediately or gradually destroyed to prevent later detection or unauthorized access to on-board sensor data. According to an exemplary embodiment, these command and control operations can also be performed from the command server 806.

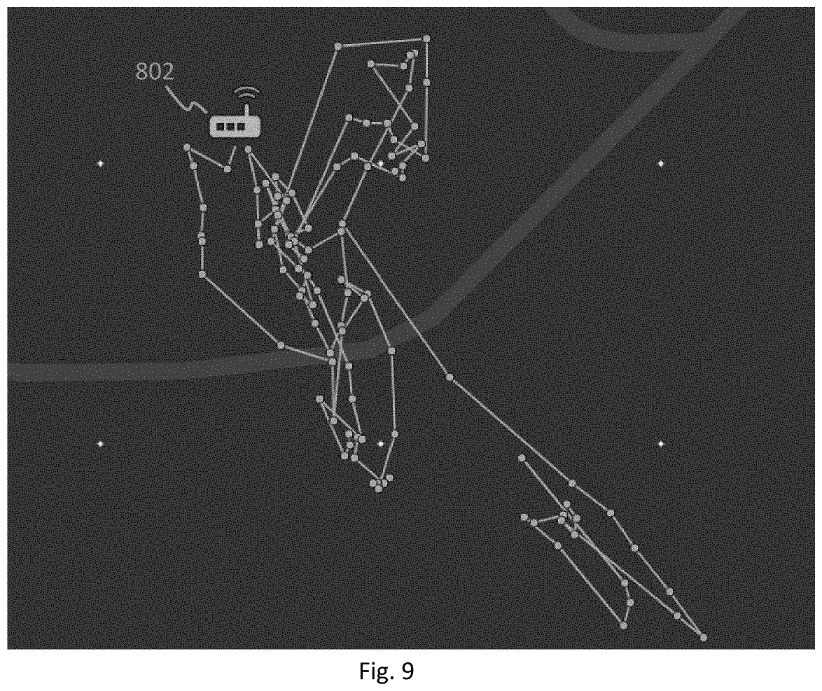

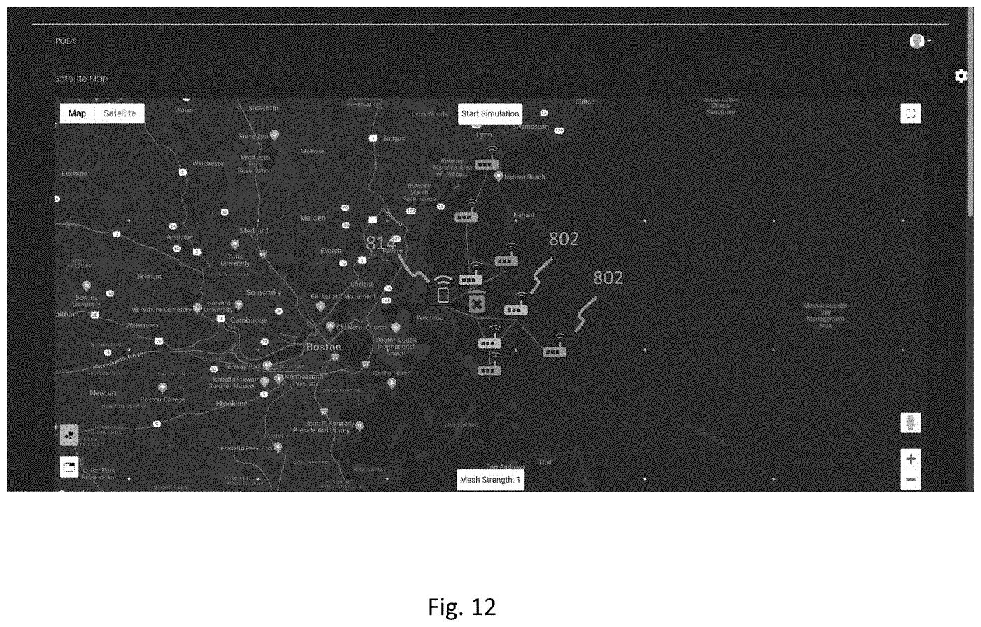

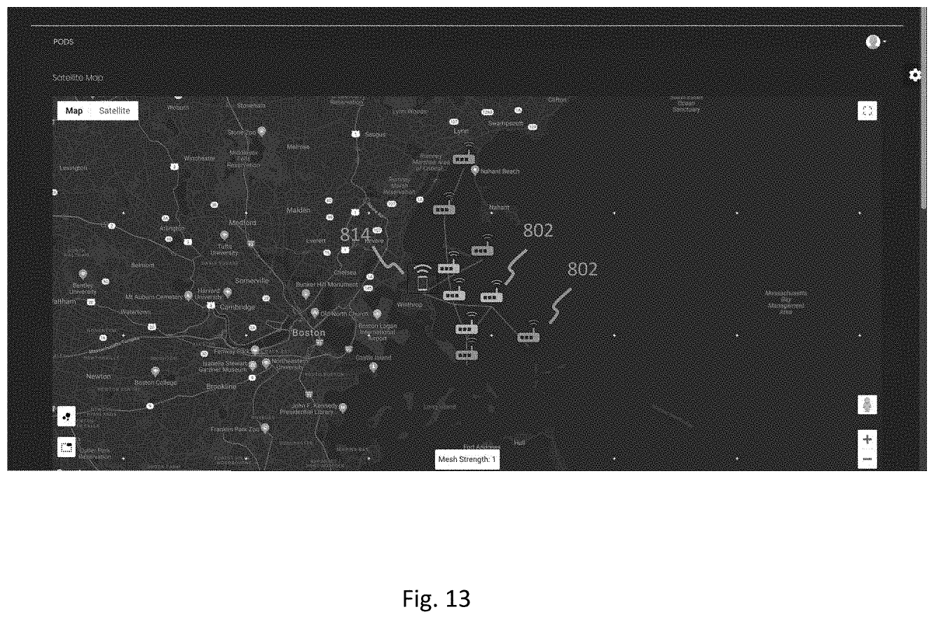

The command server 806 can include a processor 811 configured to execute program code for generating one or more real-time visualizations of sensor data received from one or more of the plural sensors 802 deployed in the area of interest. The command server 806 can also include an interface 813 for displaying the one or more visualizations generated by the processor 811. FIGS. 9-13 illustrate exemplary visualizations which can be generated by the command server 806. The command server is a user's point of access to all detection devices 802 connected to the network and deployed in the area of interest. The command server 806 provides real-time access to all collected sensor data and geo-location spatial location data. The command server 806 is also connected to a database 812 such that access to historical location and sensor data visualizations can be provided on demand. As shown in FIGS. 9-13, all detection devices can be displayed on a single map. Historical location data can also be displayed on the map using a bread-crumb trail. The visualization can be contextualized such that the real-time and historical data can be distinguished based on color scheme and/or display properties. The historical sensor data can be displayed for any selected detection device in a Time-Series graph or any other suitable display method as desired. In the time-series example, each graph represents a different type of RF signal classified by a selected detection device.

Based on the information provided by the visualizations of FIGS. 9-13, the collected sensor data can be detected and classified so that visualizations can be used to determine a timing (e.g., date and/or time) of when certain signals were detected to build up an understanding of the environment including the activity around each sensor. For example, the visualizations can identify activity patterns or routines that are or could be of interest to a user. Furthermore, the information can be used to determine if there are continuous signals that are constantly or consistently observed or detected in the environment. According to an exemplary embodiment, the data can be used to monitor expected signals from known sources, and determine whether all signals observed or detected in an environment are expected or from known sources. According to yet another exemplary embodiment, the sensor data and visualizations can be used to build (e.g., generate) a heat map for locating signals are on a map. The heat map allows the operator to not only understand the environment in terms of presence of signals but also identify the general area from which the signals are generated.

The type of analysis performed on the sensor data and visualizations could be a function of the type of signal or data obtained from the sensors if a group of deployed sensors includes two or more sensors of different types, then the analysis on the data gathered by the sensors would need to be analyzed using a suitable algorithm. For example, acoustic or sonar sensors can be used to detect subsurface objects or activities, whereas cameras or visual sensors can be used to generate images for detecting objects or activities on or above the surface. Therefore, the processes and algorithms used to evaluate the date must be suitable for extracting information from the properties or features of the data based on sensor type.

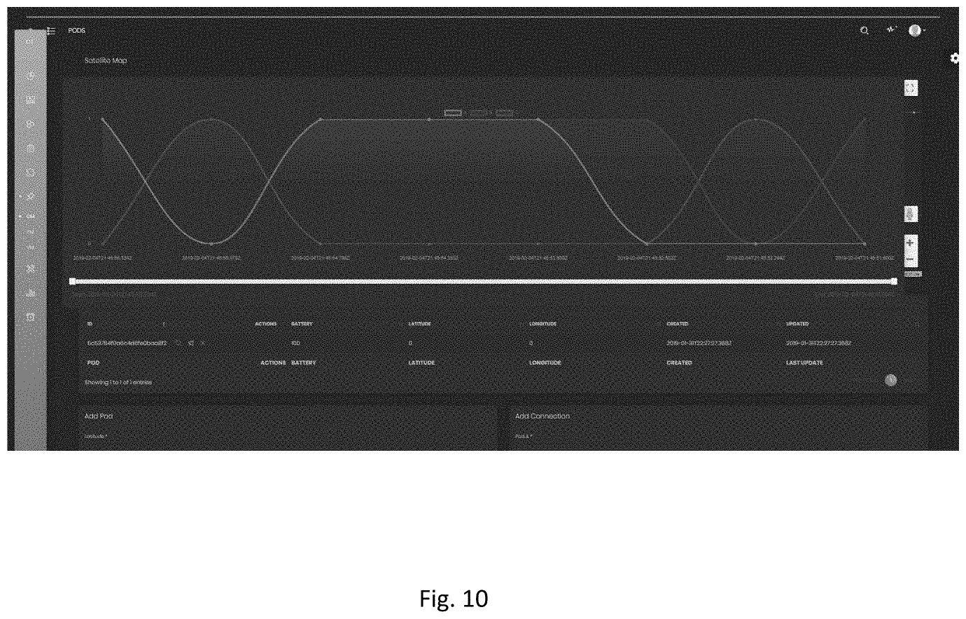

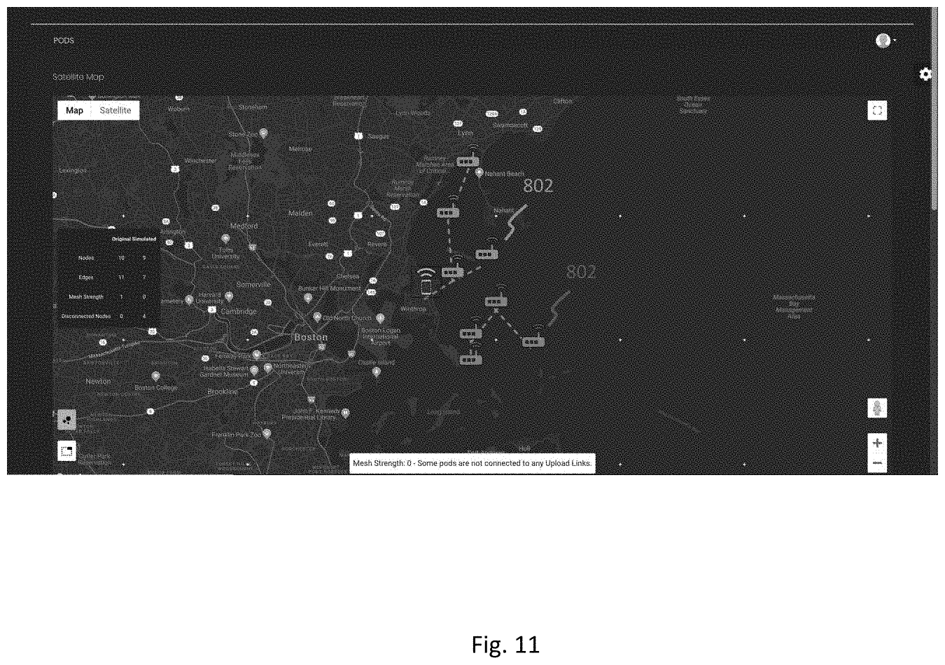

FIG. 9 illustrates a breadcrumb trail generated based on sensor data received over time from an exemplary detection device. FIG. 10 illustrates a waveform generated based on the signals detected by one or more detection devices in an area of interest. The waveform provides information on the timing of each detected signal relative to other signals detected in the area of interest, and also details a determined location of the signal source and/or detection device providing the sensor data. FIGS. 11-13 illustrate visualizations which detail the location of plural detection devices in an area of interest. The visualizations provide information on which of the plural detection devices are connected in a mesh network for communication. According to an exemplary embodiment, the visualizations can also indicate the type of computing device or detection device in the area of interest and/or the sensor type associated with each detection device.

According to an exemplary embodiment, the system as shown in FIG. 8 can include a mobile communication device 814, such as a laptop computer, smartphone, or any other suitable portable computing device as desired. The mobile communication device 814 can be configured for wireless communication with the command server 806. The mobile communication device 814 including memory encoded with program code for generating one or more visualizations of sensor data received from the command server 806, a hardware processor configured to execute the program code, and a graphical interface for displaying the one or more visualizations generated by the command server 806. According to an exemplary embodiment, the command server 806 can be configured to provide user-restricted access to the sensor data via individual user accounts. The mobile communication device 814 can be configured to execute an application that pulls data from the database 812 and/or command server 806 for display on the graphical interface.

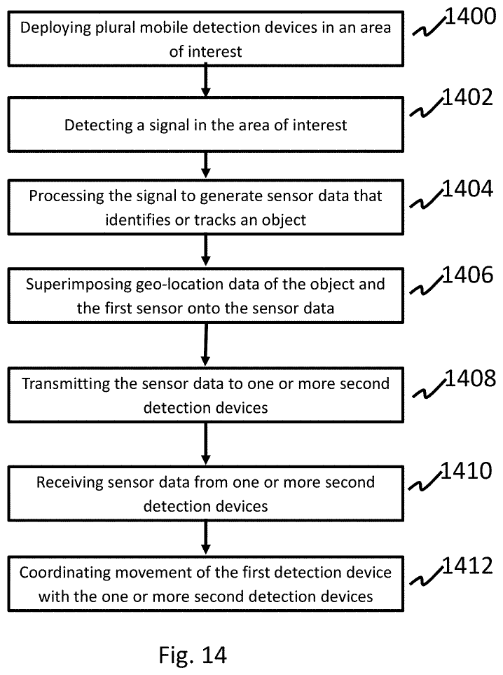

FIG. 14 illustrates an exemplary detection method in accordance with an exemplary embodiment of the present disclosure.

As shown in FIG. 14, a method for detection in an area of interest includes deploying plural mobile detection devices 802 in the area of interest (Step 1400). According to an exemplary embodiment, the deployment can be performed manually or via a mechanical launching device or system. Detecting, via a sensor 102 mounted to the first detection device 802, a signal in the area of interest (Step 1402). Processing, via the first detection device 802, the signal to generate sensor data which identifies a source of the signal or tracks an object in the area of interest (Step 1404). As already discussed, the sensor circuit 104 receives the raw sensor data via the I/O port 202 on the housing 302. The sensor circuit 104 can be configured to package the data into one or more protocol buffers for transmission on the mesh network 804. The packaged data can be raw sensor data or, prior to packaging, the sensor circuit 104 can perform identification and/or tracking processing on the received sensor data. Superimposing, via the first sensor 102, geolocation or spatial location data of the object and the first sensor 102 onto the sensor data (Step 1406). In this step, the control circuit 108 receives the packaged sensor data from the sensor circuit 104 and formats the data for transmission on the network 704 according to a specified transmission protocol. Transmitting the sensor data superimposed with the geolocation or spatial location data to one or more second detection devices 802 (Step 1408). The control circuit 108, via a transceiver 116, sends the sensor data to the command server 806 via one or more second detection devices 802 depending on the distance the first detection device 802 is from the command server 806. Receiving second sensor data from one or more second detection devices 802 in the area of interest (Step 1410). Controlling, in the first detection device 802, the motive system 316 of the housing 302 to move the first detection device 802 relative to or in coordination with the one or more second detection devices 802 to maintain observation of the detected object or detection of a signal or source (Step 1412).

The exemplary detection system of the present disclosure will now be described according to a specific implementation.

Operators may want to perform a reconnaissance mission along a beach or shoreline to get an idea of the pattern of life prior to executing a future operation. Plural detection devices 100 can be deployed remotely, manually, or autonomously from a marine vessel. The detection devices can be deployed along the beach and remotely activated to monitor the area for any signals. Once a signal is detected, the classifier onboard each detection device 100 identifies or classifies the detected signal and areas of signal concentration. That is, one or more detection devices 100 may detect the same or different signals and, based on an exchange of data, determine the degree to which the signals are concentrated in certain areas along the beach. Using the mesh network 704, the detection devices can communicate collected data to the command server 806 where the operators can build a heat map (e.g., visualization of signal concentrations) of these areas and use this information to plan or prepare for the future operation. Using the information gathered, the deployment of military can be planned in the context of an opportune time to land a force on the beach. Another option may involve further investigation of the areas of interest based on the data obtained or dispatch of additional equipment into the areas.

In another example, operators can deploy the detection devices 802 along a shoreline to monitor an area already under their control. Using a signal classifier, the operators can gather data that is used to determine whether there are any foreign signals (e.g., signals they did not generate) and investigate further to determine the source of the foreign signals.

A person having ordinary skill in the art may appreciate that embodiments of the disclosed subject matter can be practiced with various computer system configurations, including multi-core multiprocessor systems, minicomputers, mainframe computers, emulated processor architectures, computers linked or clustered with distributed functions, as well as pervasive or miniature computers that may be embedded into virtually any device. For instance, at least one processor device and a memory may be used to implement the above described embodiments.

A hardware processor device as discussed herein may be a single hardware processor, a plurality of hardware processors, or combinations thereof. Hardware processor devices may have one or more processor “cores.” The term “non-transitory computer readable medium” as discussed herein is used to generally refer to tangible media such as a memory device. The hardware processor may or may not have an RF front-end integrated with it—that is, the processing of collected data may occur either in the device with the antenna directly attached to it, or on another processor device operating on signal data that was collected and communicated to it.

After reading this description, it will become apparent to a person skilled in the relevant art how to implement the present disclosure using other computer systems and/or hardware architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The hardware processors disclosed herein can be a general purpose processor device configured with program code for performing the methods and/or method steps according to the exemplary embodiments. As a result, any general purpose processor in the context of the disclosed embodiments could also be deemed a special purpose device, respectively. The hardware processor device can be connected to a communications infrastructure, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, RF, or any combination thereof. Other suitable network types and configurations will be apparent to persons having skill in the relevant art. The computing devices disclosed herein can also include memory (e.g., random access memory, read-only memory, etc.), and may also include one or more additional memories. The memory and the one or more additional memories may be read from and/or written to in a well-known manner. In an embodiment, the memory and the one or more additional memories may be non-transitory computer readable recording media.

According to an exemplary embodiment of the present disclosure, data stored in a computing device (e.g., in the memory) may be stored on any type of suitable computer readable media, such as optical storage (e.g., a compact disc, digital versatile disc, Blu-ray disc, etc.), magnetic tape storage (e.g., a hard disk drive), or solid-state drive. An operating system can be stored in the memory.

In an exemplary embodiment, the data may be configured in any type of suitable database configuration, such as a relational database, a structured query language (SQL) database, a distributed database, an object database, etc. Suitable configurations and storage types will be apparent to persons having skill in the relevant art.

The computing device may also include an RF interface path. The RF interface path may be configured to allow software and data to be transferred between the computing device and external devices. Exemplary communications interfaces may include a modem, a network interface (e.g., an Ethernet card), a communications port, a PCMCIA slot and card, etc. Software and data transferred via the communications interface may be in the form of signals, which may be electronic, electromagnetic, optical, or other signals as will be apparent to persons having skill in the relevant art. The signals may travel via a communications path, which may be configured to carry the signals and may be implemented using wire, cable, optical, phone line, cellular phone link, radio frequency link, or any other suitable communication technology as desired.

Memory semiconductors (e.g., DRAMs, etc.) may be means for providing software to the computing device. Computer programs (e.g., computer control logic) may be stored in the memory. Computer programs may also be received via the communications interface. Such computer programs, when executed, may enable computing device to implement the present methods as discussed herein. In particular, the computer programs stored on a non-transitory computer-readable medium, when executed, may enable hardware processor device to implement the functions/methods disclosed herein, or similar methods as desired. Accordingly, such computer programs may represent controllers of the computing device. Where the present disclosure is implemented using software, the software may be stored in a non-transitory computer readable medium and loaded into the computing device using a removable storage drive or communications interface.

The computing device may also include a transceiver which performs functions pertaining to analog to digital signal conversion. The computing device may also include an RF front end which performs RF signal processing functions on an RF signal. The computing device may also contain a power device which powers the device to perform its designated functions.

Thus, it will be appreciated by those skilled in the art that the disclosed systems and methods can be embodied in other specific forms without departing from the spirit or essential characteristics thereof. The presently disclosed embodiments are therefore considered in all respects to be illustrative and not restrictive. It is not exhaustive and does not limit the disclosure to the precise form disclosed. Modifications and variations are possible in light of the above teachings or may be acquired from practicing the disclosure, without departing from the breadth or scope. Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The scope of the invention is indicated by the appended claims rather than the foregoing description and all changes that come within the meaning and range and equivalence thereof are intended to be embraced therein.

What is claimed is:

1. A detection system, comprising:
plural detection devices configured to be deployed in an area of interest, each detection device including:
a housing with an attached sensor type or having a port for detachably mounting one or more sensors of one or more sensor types;
one or more sensor circuits configured to receive sensor data from the sensors and package the sensor data for transmission over a network; and
a control circuit configured to establish communication with the network for sending or receiving sensor data to or from, respectively, other devices connected to the network.

2. The system according to claim 1, comprising:
a command server configured to monitor and control each deployed detection device within the area of interest, wherein each detection device is configured to transmit at least one of obtained or processed sensor data to the command server.

3. The system according to claim 2, comprising:
a motive system built into the housing or attached to the housing and associated with a mode of transport appropriate for movement in the area of interest,
wherein the control circuit is configured to control the motive features of the housing for moving the device to a geo-location or spatial location in the area of interest according to the mode of transport, and
wherein the command server is configured to receive geo-location or spatial data from at least one detection device, and send control signals to the control circuit for controlling the motive features of the housing of the at least one detection device to position or move the at least one detection device within the area of interest.

4. The system according to claim 3, wherein a first detection device of the one or more detection devices is configured to receive geo-location or spatial data from at least one second detection device, and control the motive features of the housing of the first detection device to coordinate a respective position or movement with the at least one second detection device, wherein the received geo-location or spatial data indicates a position or movement of at least one second detection device.

5. The system according to claim 2, wherein at least one of the one or more plural detection devices is connected to the command server as an intermediary communication device to receive or transmit data from or to, respectively, the command server and one or more other detection devices.

6. The system according to claim 1, wherein a first detection device of the one or more detection devices is configured to receive spatial data from at least one second detection device of the one or more detection devices and process the data to perform one or more of detection, identification or tracking.

7. The system according to claim 1, wherein the motive system includes a propulsion system for movement on land, or through air, space, or water.

8. The system according to claim 7, wherein the control circuit is configured to control the motive system for full or partial submersion of the housing in water.

9. The system according to claim 1, wherein the sensor data for transmission is raw sensor data or data resulting from the detection device processing the raw sensor data prior to transmission to the command server.

10. The system according to claim 9, wherein the sensor circuit is configured to package the raw sensor data or the data resulting from the detection device processing the raw sensor data into one or more protocol buffers.

11. The system according to claim 1, wherein the command server includes:
a memory encoded with program code for causing the control circuit to perform one or more actions including:
generating one or more real-time visualizations of sensor data received from at least one of the one or more sensors, or
remotely controlling one or more of the deployed sensors,
the control circuit including a processor configured to execute the program code encoded in the memory, and
an interface for:
displaying the one or more visualizations generated by the processor, or
transmitting sensor data or the one or more visualizations for automated or other processing or command and control functions.

12. The system according to claim 11, wherein the one or more real-time visualizations displayed by the interface includes one or more of:
real-time geo-location or spatial data of at least one of the one or more detection devices;
historical location data displayed as a breadcrumb trail of at least one of the one or more detection devices; and
a time series graph of historical signal data collected and classified by a respective sensor, wherein each series displayed in the time series graph represents a different type of signal.

13. The system according to claim 11 comprising:
a database configured to store sensor data communicated to the command server from the one or more detection devices.

14. The system according to claim 1, comprising:
a mobile communication device configured for wireless communication with the command server, the mobile communication device including memory encoded with program code for generating one or more visualizations of sensor data received from the command server, a processor configured to execute the program code, and an interface for displaying the one or more visualizations generated by the processor.

15. A detection apparatus, comprising:
a housing having one or more ports for detachably mounting one or more sensors of one or more sensor types and including a motive system associated with a mode of transport for movement in an area of interest;
a sensor circuit configured to receive sensor data via the port and package the sensor data for transmission over a network; and
a control circuit configured to:
establish communication with the network for sending or receiving sensor data to or from other devices, respectively, that are connected to the network; and
control the motive system of the housing for moving the apparatus to locations in the area of interest.

16. The apparatus according to claim 15, wherein the housing includes an inner chamber, the apparatus comprising:
a card removably mounted within the inner chamber;
a substrate mounted on the card;
components of the sensor circuit mounted on the substrate;
a battery mounted to the substrate, wherein the battery is rechargeable; and
one or more photovoltaic cells mounted to the housing and configured to supply the battery with energy for charging.

17. The apparatus according to claim 15, wherein the sensor is configured to detect:
an RF signal emitted by an object or capture an image of an object, or
maritime signals transmitted by maritime vessels or cellular signals.

18. The apparatus according to claim 15, wherein the control circuit includes:
circuitry configured for communication over a mesh network; and
a processor configured with program code for converting the sensor data to protocol buffers for transmission over the mesh network.

19. The apparatus according to claim 15, wherein:
the motive system includes a propulsion system for one of movement on land, or through air, space, or water;
the control circuit for a water motive system is configured to control the motive features for full or partial submersion of the housing in water, and
the control circuit of a first detection apparatus is configured to receive geo-location or spatial data indicating a position or movement of at least one other detection device and control the motive system of the first detection apparatus to coordinate a position or movement relative to the at least one other detection apparatus.

20. A method for detection in an area of interest, comprising:
deploying one or more mobile detection devices in the area of interest;
detecting, via a sensor mounted to a first detection device, a signal in the area of interest;
processing, via the first detection device, the signal to generate sensor data that identifies or tracks an object in the area of interest;
superimposing, via the first detection device, geo-location or spatial data of the object and the detection device onto the sensor data;
processing, via the one or more second detection devices, their respective signals from the area of interest to generate respective processed sensor data that identifies or tracks the object in the area of interest and superimposing their respective geo-location or spatial data onto their respective processed sensor data;
one or more second detection devices transmitting via a network to the first detection device their processed data with their superimposed geo-location or spatial sensor data related to the object in the area of interest;
the first detection device receiving via the network from the one or more second detection devices their respective processed sensor data with their superimposed geo-location or spatial sensor data related to the object in the area of interest;
superimposing, via the first detection device, the geo-location or spatial data of the object and the first detection device onto the sensor data; and
moving, the first detection device relative to or in coordination with the one or more second detection devices to maintain observation of the detected object.
